(19) United States
(12) Patent Application Publication
(10) Pub. No.: US 2011/0033077 A1
(43) Pub. Date: Feb. 10, 2011

(54) MAGNET SYSTEM AND METHOD OF MANUFACTURING THE SAME

(75) Inventors: Maria Papakyriacou, Wien (AT); Heinz Renner, Kaltenleutgeben (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/937,377

(22) PCT Filed: Apr. 3, 2009
(86) PCT No.: PCT/IB2009/051403

§ 371 Date: Oct. 12, 2010

(30) Foreign Application Priority Data
Apr. 15, 2008 (EP) 08103547.9

(51) Int. Cl. H04R 11/02; B23K 31/02; B23K 13/01; B23K 1/002

(52) U.S. Cl. 381/396; 228/101; 228/203; 219/615; 219/616

(57) ABSTRACT

A method of manufacturing a magnet system (101, 201) for an electro-acoustic transducer (100, 200) comprising a magnet element (105, 205) and at least one pole plate (106, 107, 206, 207), is described, wherein the method comprises providing the magnet element (105, 205) having a first coating layer comprising a first corrosion resistant material, providing the at least one pole plate (106, 107, 206, 207) having a second coating layer comprising a second corrosion resistant material, and connecting said magnet element (105, 205) and said at least one pole plate (106, 107, 206, 207) by fusing the first coating layer and the second coating layer.

### FIELD OF THE INVENTION

The invention relates to a magnet system, in particular for an electro-acoustic transducer. Moreover, the invention relates to an electro-acoustic transducer. Finally, the invention relates to a method of manufacturing an electro-acoustic transducer.

### BACKGROUND OF THE INVENTION

Magnet systems are widely used in electro-acoustic transducers, like loudspeakers. In particular, such magnet systems are used in miniature loud speakers and comprise at least two parts, i.e. a magnet element and pole plates. These parts are coated by a corrosion resistant layer and then glued together using a fast hardening adhesive.

### OBJECT AND SUMMARY OF THE INVENTION

There is a need to provide an alternative method of manufacturing a magnet system for an electro-acoustic transducer, an alternative magnet system for an electro-acoustic transducer and an alternative electro-acoustic transducer exhibiting improved characteristics.

In order to meet the need defined above, a method of manufacturing a magnet system for an electro-acoustic transducer, a magnet system for an electro-acoustic transducer and an electro-acoustic transducer according to the independent claims are provided. Further improvements are disclosed in the dependent claims.

According to an exemplary aspect of the invention, a method of manufacturing a magnet system for an electro-acoustic transducer comprising a magnet element and at least one pole plate is provided, wherein the method comprises the steps of providing the magnet element having a first coating layer comprising a first corrosion resistant material, providing the at least one pole plate having a second coating layer comprising a second corrosion resistant material, and connecting said magnet element and said at least one pole plate by fusing the first coating layer and the second coating layer. In particular, the first and the second corrosion resistant material may be the same material and/or the first coating layer of the first corrosion resistant material and/or the second coating layer may consist of the second corrosion resistant material. Moreover, the first and/or second corrosion resistant material may have a low melting point, e.g. a melting point of less than 500° C., in particular less than 350° C. and preferably less than 250° C.

According to an exemplary aspect of the invention, a magnet system for an electro-acoustic transducer is provided, wherein the magnet system comprises a magnet element having a first coating layer comprising a first corrosion resistant material, and at least one pole plate having a second coating layer comprising a second corrosion resistant material, wherein the magnet element and the at least one pole plate are connected to each other by fusing the first coating layer and the second coating layer to each other. In particular, the magnet system may further comprise a second pole plate having a third coating layer comprising a third corrosion resistant material, wherein the second pole plate may be connected to the magnet element by fusing the first coating layer and the third coating layer.

According to an exemplary aspect of the invention an electro-acoustic transducer is provided, which comprises a housing, a magnet system according to an exemplary aspect of the invention, a membrane, and a coil, wherein the magnet system is attached to the housing, wherein the coil is attached to the membrane, and wherein the coil and the magnet system are arranged in such a way that the coil actuates the membrane when a current is applied to the coil.

By providing a method of manufacturing a magnet system by connecting at least two coated elements of the magnet system by fusing of the coatings it may be possible to omit the necessity of an adhesive in particular of a fast hardening adhesive. Such fast hardening adhesives are in general expensive and hard to handle. Furthermore, the method according to an exemplary aspect of the invention may ensure a simpler processing, e.g. may enable omitting an extra process step of applying an adhesive in addition to a coating step for corrosion protection. Furthermore, it may be possible to ensure that the strength of the magnet field is not attenuated by the adhesive layer when the coating layer itself is used to fuse the parts of the magnet system together. Moreover, it may be possible to avoid that the parts peel off or detach from each other due to an adhesive layer having a low thickness, which usually is minimized to ensure that the magnetic field is not attenuated to a great extend.

It may be seen as a gist of an exemplary embodiment of a magnet system for an electro-acoustic transducer, e.g. a loudspeaker, that a corrosion resistant layer of a magnet element, e.g. a permanent magnet, and at least a first pole plate is coated which is used as a corrosion protection as well as a fusion layer, i.e. as a layer which is used to connect the connect the magnet element and the first pole plate by fusing the coating layers of both of the components. Thus, it may be possible to avoid the using of a corrosion protection layer and a separate adhesive layer as it is commonly performed when magnet systems and/or loudspeakers are manufactured so that the processing procedure may be simplified and may be reduced in costs.

Next, further exemplary embodiments of the method of manufacturing a magnet system are described. However, these embodiments also apply to the magnet system and the electro-acoustic transducer.

According to another exemplary embodiment the method further comprises manufacturing the magnet element by applying the first corrosion resistant material to a raw magnet element and manufacturing the at least one pole plate by applying the second corrosion resistant material to a raw pole plate. For example, the raw magnet element may form a core of the magnet element and may be coated by the first coating layer to provide the magnet element. Also the raw pole plate may form a core of the pole plate and may be coated by the second coating layer to provide the pole plate.

According to another exemplary embodiment of the method the fusion is performed by one of the processes out of the group consisting of induction soldering, induction brazing, and heating by using a heater.

In particular, the heating may be performed by using a heater, or oven, or by using heat conduction, or flame. In principle every heating process is suitable which ensures that the coating layers are at least partially melt while the integrity of the core material of the magnet element and the core material of the at least one pole plate is not affected.

According to another exemplary embodiment of the method the first corrosion resistant material and/or the second corrosion resistant material is a material having a low melting temperature, in particular a metallic material like tin. Alternatively, the corrosion resistant materials may be a thermoplastic material or any suitable material having a low melting point, e.g. a melting temperature which is lower than a temperature other parts of the magnet system lose their integrity or intactness. Preferably, material is used as the coating layers which also ensure that the manufactured magnet system may have a smooth surface. In particular, the coating or the material the coating is comprised of may act as soldering agent.

According to another exemplary embodiment the method further comprises providing a second pole plate having a third coating layer comprising a third corrosion resistant material, and connecting said magnet element and said second pole plate by fusing the first coating layer and the third coating layer. In particular, the first, second and third corrosion resistant material may be the same material and/or the second pole plate may be manufactured by applying the third corrosion resistant material to a raw pole plate.

Summarizing, one exemplary aspect of the invention may be seen in the fact that a method of manufacturing a magnet system for a electro-acoustic transducer, e.g. a loudspeaker, is provided comprising steps of applying a coating layer of a corrosion resistant material to some or all parts of the magnet system, e.g. a magnet element, a first pole plate and a second pole plate. After the coating step the coated parts are connected by fusing the coating, e.g. by induction soldering. By using the method according to this exemplary aspect of the invention it may be possible to avoid the using of expensive adhesives to connect the parts of the magnet system with each other. Furthermore, it is possible to simplify the manufacturing process by reducing the necessary process steps by using the same coating as a corrosion protection and assembly means, e.g. the means or material used for connecting the parts with each other, so that no additional process step of applying an adhesive layer may be necessary. By omitting the adhesive layer it is also possible to perform the fusing in one process step and to reduce the weakening or attenuation of a magnetic field which occurs when using an adhesive layer as in common manufacturing methods. Furthermore, it is possible to ensure that the coating layer and thus the layer functioning simultaneously as a connection layer and a corrosion protection is applied to the whole parts or elements. Moreover, the fusion or connecting quality or performance may be increased while the stress resistance, e.g. due to shock, may be increased. Thus, the shock-toughness may be increased. Such loudspeakers may be used in receivers for mobile communication e.g. in mobile phones.

The aspects and embodiments defined above and further aspects of the invention are apparent from the examples of embodiment to be described hereinafter and are explained with reference to these examples of embodiment. It should be noted that features described in connection with a specific exemplary embodiment or exemplary aspect may be combined with another exemplary embodiment or another exemplary aspect.

### BRIEF DESCRIPTION OF THE DRAWINGS

The invention will be described in more detail hereinafter with reference to examples of embodiments but to which the invention is not limited.

FIG. 1 schematically illustrates a first type of loudspeaker, in which a magnet system according to an exemplary embodiment of the invention may be used.

FIG. 2 schematically illustrates a second type of loudspeaker, in which a magnet system according to an exemplary embodiment of the invention may be used.

### DESCRIPTION OF EMBODIMENTS

The illustration in the drawing is schematic. In different drawings, similar or identical elements are provided with similar or identical reference signs.

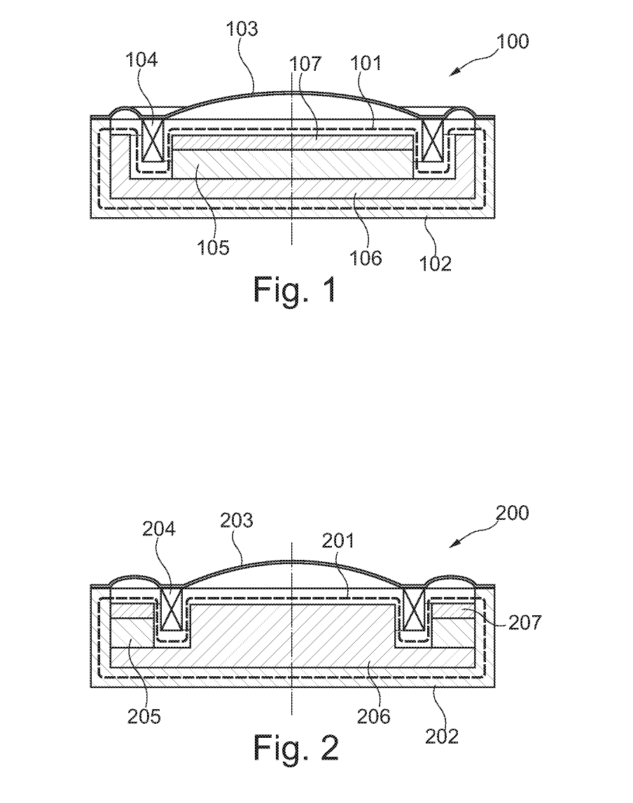

For the following illustration of an electro-acoustic transducer or loudspeaker reference is made to FIGS. 1 and 2.

FIG. 1 schematically shows a first loudspeaker 100, comprising a housing 102, a membrane 103, and a coil 104. Furthermore, the loudspeaker 100 comprises a magnet system 101, comprising a magnet element or magnet 105, a first pole plate or yoke 106 and a second pole plate or yoke 107. The magnet system 101 of the loudspeaker 100 is manufactured by using a method according to an exemplary embodiment of the invention, e.g. all parts of the magnet system are first coated by a corrosion resistant material, which also has a low melting point, e.g. tin, and then connected to each other by a fusing process, e.g. by induction soldering. In the embodiment shown in FIG. 1 the magnet element 105 and the second pole plate 107, arranged on the magnet element, are arranged in the central part of the loudspeaker 100 and of the membrane 103.

FIG. 2 schematically shows a second loudspeaker 200, comprising a housing 202, a membrane 203, and a coil 204. Furthermore, the loudspeaker 200 comprises a magnet system 201, comprising a magnet element or magnet 205, a first pole plate or yoke 206 and a second pole plate or yoke 207. The magnet system 201 of the loudspeaker 200 is manufactured by using a method according to an exemplary embodiment of the invention, e.g. all parts of the magnet system are first coated by a corrosion resistant material, which also has a low melting point, e.g. tin, and then connected to each other by a fusing process, e.g. by induction soldering. Contrary to the embodiment shown in FIG. 1, in the embodiment shown in FIG. 2 the magnet element 205 and the second pole plate 207, arranged on the magnet element, are arranged in the periphery part of the loudspeaker 200 and of the membrane 203.

Summarizing, a manufacturing method of a magnet system for an electro-acoustic transducer is provided, wherein the method is less complex and comprises less process steps, which may also lead to reduced costs, by providing a corrosion resistant coating which may also be used as a fusing or soldering agent. Furthermore, the magnetic flux may in the magnet system may be increased due to the absent of a glue layer while possibly increasing the performance of the mechanical connection of the parts of the magnet system.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprise” and its conjugations do not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A method of manufacturing a magnet system for an electro-acoustic transducer comprising a magnet element and at least one pole plate, the method comprising the steps of:
providing the magnet element having a first coating layer comprising a first corrosion resistant material;
providing the at least one pole plate having a second coating layer comprising a second corrosion resistant material; and
connecting said magnet element and said at least one pole plate by fusing the first coating layer and the second coating layer.

2. The method as claimed in claim 1, further comprising:
manufacturing the magnet element by applying the first corrosion resistant material to a raw magnet element; and
manufacturing the at least one pole plate by applying the second corrosion resistant material to a raw pole plate.

3. The method as claimed in claim 1,
wherein the fusing is performed by at least one of:
induction soldering;
induction brazing; and
heating by using a heater.

4. The method according to claim 1,
wherein at least one of the first corrosion resistant material and the second corrosion resistant material is a material having a low melting temperature.

5. The method according to claim 1, further comprising:
providing a second pole plate having a third coating layer comprising a third corrosion resistant material; and
connecting said magnet element and said second pole plate by fusing the first coating layer and the third coating layer.

6. A magnet system for an electro-acoustic transducer, the magnet system comprising:
a magnet element having a first coating layer including a first corrosion resistant material; and
at least one pole plate having a second coating layer including a second corrosion resistant material,
wherein the magnet element and the at least one pole plate are connected to each other by fusing the first coating layer and the second coating layer to each other.

7. The magnet system as claimed in claim 6, further comprising:
a second pole plate having a third coating layer including a third corrosion resistant material,
wherein the second pole plate is connected to the magnet element by fusing the first coating layer and the third coating layer.

8. An electro-acoustic transducer, comprising:
a housing;
a magnet system according to claim 6, wherein the magnet system is attached to the housing;
a membrane; and
a coil attached to the membrane,
wherein the coil and the magnet system are arranged in such a way that the coil actuates the membrane when a current is applied to the coil.

9. The method according to claim 4, wherein at least one of the first corrosion resistant material and the second corrosion resistant material includes tin.
